(19) United States
(12) Patent Application Publication
(10) Pub. No.: US 2015/0071723 A1
(43) Pub. Date: Mar. 12, 2015

(54) HEADSTOCK OF MACHINE TOOL

(71) Applicant: Okuma Corporation, Niwa-Gun (JP)

(72) Inventor: Yoshio NAKATSUKASA, Niwa-Gun (JP)

(21) Appl. No.: 14/463,931

(22) Filed: Aug. 20, 2014

(30) Foreign Application Priority Data
Sep. 12, 2013 (JP) 2013-189595

(51) Int. Cl. B23C 9/00

(52) U.S. Cl. CPC B23C 9/005; B23C 2260/04
USPC 409/204

(57) ABSTRACT

A headstock is formed by a spindle head to which a tool can be attached, a support base, etc. The spindle head is rotated about a central axis (rotation axis) of a cylindrical rotary spindle and indexed to a predetermined attitude by a rotation drive mechanism built in the support base. The headstock includes a braking mechanism that restrains rotation of the rotary spindle by pressing a piston against a brake plate by using an oil pressure. When the braking mechanism is operated, hydraulic force is applied to a braking member of the rotary spindle in the opposite direction to the direction in which the piston is pressed against the brake plate, so that the braking member is pressed against a reference surface provided in the support base.

### BACKGROUND OF THE INVENTION

This application claims the benefit of Japanese Patent Application Number 2013-189595 filed on Sep. 12, 2013, the entirety of which is incorporated by reference.

### FIELD OF THE INVENTION

The present invention relates to headstocks mounted on machine tools such as combination machining lathes and including a rotary spindle that is capable of rotating a spindle head having a tool attached thereto about a rotation axis, and a braking mechanism that slows down or stops rotation of the rotary spindle.

### DESCRIPTION OF RELATED ART

Machine tools such as multitasking machine tools are provided with a headstock (so-called milling headstock) that has a main spindle having a tool attached thereto and a rotary spindle capable of rotating and indexing the main spindle about a rotation axis (axis perpendicular to the main spindle). Such a milling headstock is proposed in Japanese Patent Application Publication No. 2010-23148 (JP 2010-23148 A). In this proposed milling headstock, a sleeve member has a tapered surface subjected to surface treatment (e.g., diamond plating) on its outer periphery in order to increase frictional resistance, and is capable of advancing and retracting along the axial direction of the rotary spindle. Further, in the proposed milling headstock, a support base rotatably holding the rotary spindle has a tapered surface facing the tapered surface of the sleeve member. The rotary spindle is braked by pressing the tapered surface of the sleeve member against the tapered surface of the support base by using an oil pressure.

There is also a milling headstock that has a flat plate-shaped brake plate (rotating brake plate) on the outer periphery of a rotary spindle and a brake plate (fixed brake plate) on the inner periphery of an insertion hole of a support base having the rotary spindle inserted therein, such that these brake plates face each other. In this milling headstock, a piston is advanced or retracted along the rotary spindle by using an oil pressure, the rotating brake plate is held between a head of the piston and the fixed brake plate, and the rotary spindle is thus braked.

In the milling headstock of JP 2010-23148 A, a braking mechanism (brake mechanism) for the rotary spindle can quickly rotate and index the main spindle to an accurate position. However, it is difficult to machine the sleeve member etc. as a component of the brake mechanism. The milling headstock therefore cannot be produced inexpensively. If the tapered surface of the sleeve member is worn away, the entire sleeve member needs to be replaced, which makes maintenance expensive and troublesome.

In the milling headstock that brakes the rotary spindle by holding the rotating brake plate between the head of the piston and the fixed brake plate by using an oil pressure, the hydraulic force is applied in one direction (e.g., the direction toward the top end of the rotary spindle) when the rotary spindle is braked. The rotary spindle therefore tends to be displaced (shifted).

### SUMMARY OF THE INVENTION

It is an object of the present invention to provide a practical headstock of a machine tool, which solves the above disadvantages of the headstocks headstocks) of the conventional machine tools, which allows a brake mechanism for a rotary spindle capable of quickly rotating and indexing a main spindle to an accurate position to be produced inexpensively, whose maintenance is easy, and in which the rotary spindle is less likely to be displaced (shifted).

According to a first aspect of the present invention, a headstock of a machine tool includes a main spindle capable of rotating with a tool being attached thereto, a rotary spindle capable of indexing the main spindle about a rotation axis perpendicular to the main spindle, a support base rotatably holding the rotary spindle, and a braking mechanism that restrains rotation of the rotary spindle. In the headstock, the braking mechanism restrains rotation of the rotary spindle by pressing a piston fixed to the support base against a brake plate fixedly attached to the rotary spindle by using an oil pressure. When the braking mechanism is operated, hydraulic force is applied to a braking member of the rotary spindle in an opposite direction to a direction in which the piston is pressed against the brake plate, so that the braking member is pressed against a reference surface provided in the support base.

According to a second aspect of the present invention, in the invention according to the first aspect, the support base rotatably holding the rotary spindle has an inlet chamber that is to be filled with hydraulic oil to be supplied to operate the piston. An oil pressure application surface is provided in the inlet chamber so as to face a base end face of the piston.

According to a third aspect of the present invention, in the invention according to the first or second aspect, the headstock of the machine tool further includes, in addition to the braking mechanism, a second braking mechanism. The second braking mechanism restrains rotation of the rotary spindle by causing a first clutch member fixed to the support base to mesh with a second clutch member fixedly attached to the rotary spindle by using an oil pressure. Either the braking mechanism or the second braking mechanism is used according to an indexing angle. In the headstock, when the second braking mechanism is operated, the second clutch member meshing with the first clutch member by the oil pressure is pressed against the reference surface provided in the support base.

In the headstock of the machine tool according to the first aspect, the main spindle can be quickly rotated and indexed to an accurate position. Further, the braking mechanism (brake mechanism) for the rotary spindle can be produced inexpensively, and maintenance is easy. Moreover, when the rotary spindle is braked, the hydraulic force is applied in the opposite direction to the direction in which the piston is pressed against the brake plate, and therefore the rotary spindle is less likely to be displaced (shifted).

In the headstock of the machine tool according to the second aspect, the pressure of hydraulic oil pressing the piston is applied to the oil pressure application surface when the rotary spindle is braked. Accordingly the hydraulic force can be efficiently applied in the opposite direction to the direction in which the piston is pressed against the brake plate. This can more accurately prevent displacement of the rotary spindle.

In the headstock of the machine tool according to the third aspect, the rotary spindle is braked by using either the braking mechanism or the second braking mechanism according to the indexing angle. Accordingly, the rotary spindle can be braked in a short time, and a spindle head can be indexed to a very accurate position. Moreover, regardless of whether indexing is performed by using the brake-type braking mechanism or the clutch-type braking mechanism, the same reference surface is pressed by using the oil pressure. Therefore, displacement (shifting) of the rotary spindle along the rotation axis is reduced.

### BRIEF DESCRIPTION OF THE DRAWINGS

FIG. 1 is a partial sectional view of a headstock (milling headstock) mounted on a combination machining lathe.

FIGS. 2A and 2B are illustrations showing the operating state of a braking mechanism for the headstock.

### DETAILED DESCRIPTION OF THE EMBODIMENTS

### (1) Structure of Headstock

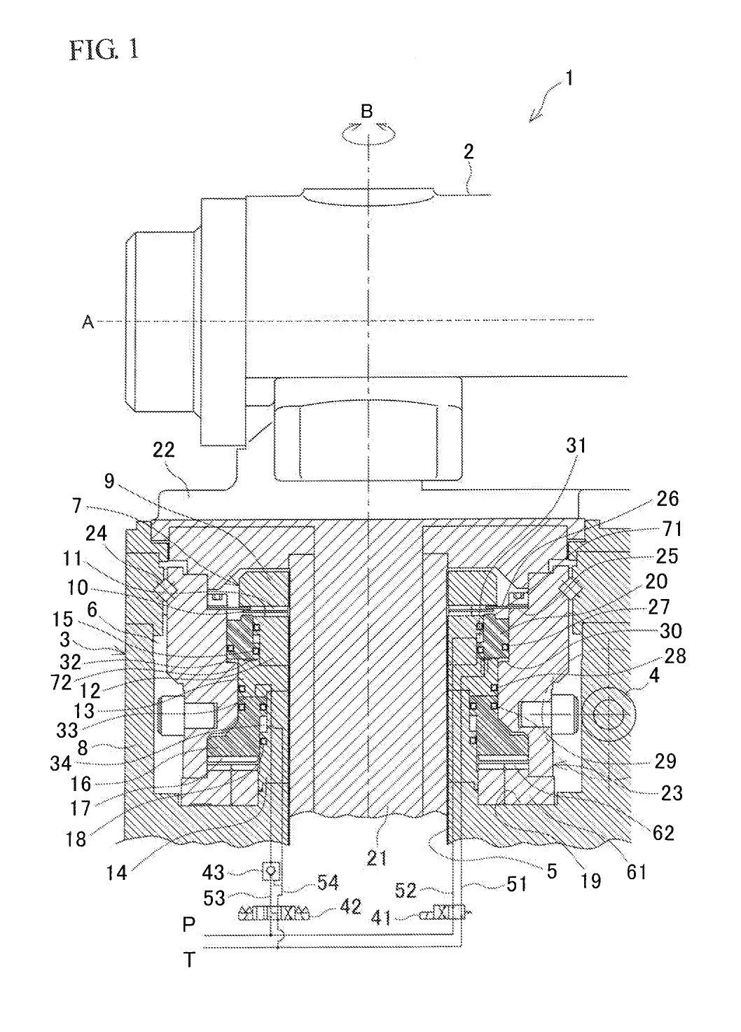

An embodiment of a headstock of a machine tool according to the present invention will be described in detail with reference to the accompanying drawings. FIG. 1 is a partial sectional view of a headstock (milling headstock) mounted on a combination machining lathe (not shown) as a machine tool. FIG. 1 also shows a hydraulic circuit that operates a braking mechanism for the headstock. A headstock 1 is formed by a spindle head 2 (main spindle A) to which a tool can be attached, a support base 3, etc. The spindle head 2 is rotated about a central axis (rotation axis B) of a cylindrical rotary spindle 21 and indexed to a predetermined attitude by a rotation drive mechanism 4 built in the support base 3.

The support base 3 has a substantially cylindrical shape, and has a shaft insertion hole 5 in the center through which the rotary spindle 21 of the spindle head 2 is inserted. The support base 3 has a substantially cylindrical void 6 near a top end of the support base 3, and the void 6 is located outside the shaft insertion hole 5 (an inner support portion 7 is a portion located near the top end of the support base 3 and located outside the shaft insertion hole 5 so as to adjoin the shaft insertion hole 5, and an outer support portion 8 is a portion located outside the void 6 so as to adjoin the void 6). The support base 3 has a reference surface 19 on the base end side (lower side in FIG. 1) of the void 6. The reference surface 19 extends perpendicularly to the rotary shaft B.

A flat cylindrical brake head 9 is fixed to a top end of the inner support portion 7. A flat ring-shaped brake plate 10 is fixedly attached to the inner side (base end side) of the brake head 9 so as to be held between flat ring-shaped fixing members 11 made of rubber. A piston guide member 12, a support member 13, and a clutch guide member 14 are fixedly attached to the inner side (base end side) of the brake plate 10.

The piston guide member 12 has a flange portion at its top end. The piston guide member 12 thus has a larger diameter (larger outer diameter) in the flange portion than in the remaining portion. The clutch guide member 14 has a larger diameter on its base end side than on its top end side. The support member 13 has a larger diameter than the piston guide member 12 and the clutch guide member 14.

A flat ring-shaped piston 20 is provided on the top end side of the support member 13. This piston 20 has a stopping protrusion 71 on its top end face, and has at its base end an engagement flange protruding inward. An inner peripheral surface of the piston 20 is in contact with an outer peripheral surface of the piston guide member 12 via bearings 15. The piston 20 advances and retracts along the rotation axis B (that is, the piston 20 can be separated from and brought into contact with a top end face of the support member 13) by using an oil pressure as described below. A ring-shaped recess 72 and an inlet hole (not shown) that allows hydraulic oil to flow therein are provided in the top end face of the support member 13.

A first clutch member 16 whose outer shape is a substantially frustum is provided on the base end side of the support member 13. An engagement flange protruding inward is provided on the first clutch member 16 near its top end, and a clutch plate 17 is provided on a base end face of the first clutch member 16. An inner peripheral surface of the first clutch member 16 is in contact with an outer peripheral surface of the clutch guide member 14 via bearings 18. The first clutch member 16 advances and retracts along the rotation axis B (that is, the first clutch member 16 can be separated from and brought into contact with the base end face of the support member 13) by using an oil pressure as described below. The clutch plate 17 is a ring-shaped coupling member, and meshes with a clutch plate 62 of a second clutch member 61 described below.

A flange portion 22 is provided on a top end of the cylindrical rotary spindle 21 (between the rotary spindle 21 and the spindle head 2). A substantially cylindrical braking member 23 is fixedly attached to a lower surface of the flange portion 22. The braking member 23 is fitted in the void 6 formed between the inner support portion 7 and the outer support portion 8 of the support base 3.

A bearing 24 is interposed between an outer surface near a top end of the braking member 23 and an inner surface of the outer support portion 8 of the support base 3 so that the rotary spindle 21 can be supported by the support base 3 and smoothly rotate about the rotation axis B. The braking member 23 has a contact surface 25 near its upper end. The contact surface 25 has a ring shape with a constant width, and extends perpendicularly to the rotation axis B. A flat ring-shaped brake plate 26 is fastened to the contact surface 25 by a plurality of bolts at regular intervals (at equal angles about the rotation axis B). An inner peripheral edge portion of the brake plate 26 is interposed at a predetermined interval between outer peripheral edge portions of the brake head 9 and the brake plate 10 which are provided at the top end of the inner support portion 7 of the support base 3. The stopping protrusion 71 of the piston 20 is located on the base end side of the overlapping portion of the brake head 9, the brake plate 26, and the brake plate 10.

A central portion of the braking member 23 protrudes like a flange toward the axial center. This flange-like portion of the braking member 23 has an oil pressure application surface 30 at its top end. The oil pressure application surface 30 has a ring shape with a constant width, and extends perpendicularly to the rotation axis B. The oil pressure application surface 30 faces a lower surface of the piston 20 at a predetermined distance.

The second clutch member 61 is provided on a base end of the braking member 23 so as to protrude beyond the braking member 23 toward the axial center. The clutch plate 62 that meshes with the clutch plate 17 of the first clutch member 16 is fixedly attached to an outer surface on the top end side of the second clutch member 61. An inner peripheral surface of the braking member 23 faces an outer peripheral surface of the piston 20 with a bearing 27 interposed therebetween, faces an outer peripheral surface of the support member 13 with a bearing 28 interposed therebetween, and faces an outer peripheral surface of the first clutch member 16 with a bearing 29 interposed therebetween.

A first inlet chamber 31 capable of receiving hydraulic oil is provided between the inner peripheral surface of the piston 20 and the outer peripheral surface of the piston guide member 12. A second inlet chamber 32 capable of receiving hydraulic oil is provided below the piston 20. The second inlet chamber 32 is surrounded and closed by the lower surface of the piston 20, the inner peripheral surface of the braking member 23, the oil pressure application surface 30, the outer peripheral surface of the support member 13, and an outer top end face of the support member 13. A third inlet chamber 33 capable of receiving hydraulic oil is provided between a lower surface of the support member 13 and an upper surface of the first clutch member 16. Further, a fourth inlet chamber 34 capable of receiving hydraulic oil is provided between the inner peripheral surface of the first clutch member 16 and the outer peripheral surface of the clutch guide member 14.

As shown in FIG. 1, the first inlet chamber 31 is connected to an external pump P by a second oil passage 52 via an electromagnetic valve 41, and the second inlet chamber 32 is connected to an external tank T by a first oil passage 51 via the electromagnetic valve 41. The third inlet chamber 33 is connected to the pump P by a third oil passage 53 via a directional control valve 42 and a pilot check valve 43. The fourth inlet chamber 34 is connected to the tank T by a fourth oil passage 54 via the directional control valve 42. The pump P is drivingly controlled by a control device, not shown.

A first braking mechanism (brake-type braking mechanism) of the rotary spindle 21 is formed by the brake head 9, the brake plate 10, the brake plate 26 of the braking member 23, the piston 20, the first inlet chamber 31, the second inlet chamber 32, the first oil passage 51, the second oil passage 52, the electromagnetic valve 41, the pump P, the tank T, the control device (not shown) for the pump P, etc. A second braking mechanism (clutch-type braking mechanism) of the rotary spindle 21 is formed by the first clutch member 16, the clutch plate 17, the second clutch member 61, the clutch plate 62, the third inlet chamber 33, the fourth inlet chamber 34, the third oil passage 53, the fourth oil passage 54, the directional control valve 42, the pilot check valve 43, the pump P, the tank T, the control device (not shown) for the pump P, etc.

### (2) Operation of Headstock

In the headstock 1 having the above configuration, the second braking mechanism (clutch-type braking mechanism) is used for indexing by a large unit (angle, approximately 15° or more), and the first braking mechanism (brake-type braking mechanism) is used for indexing by a small angle (less than approximately 30°) that cannot be handled by the second braking mechanism. That is, for indexing by a large unit, the third inlet chamber 33 is filled with hydraulic oil to retract the first clutch member 16 toward the base end (move the first clutch member 16 downward in FIG. 1) so that the clutch plate 17 meshes with the clutch plate 62 of the second clutch member 61 fixedly attached to the braking member 23. A surface on the base end side (lower side in FIG. 1) of the second clutch member 61 is thus pressed against the reference surface 19 to restrain rotation of the braking member 23 with respect to the inner support portion 7.

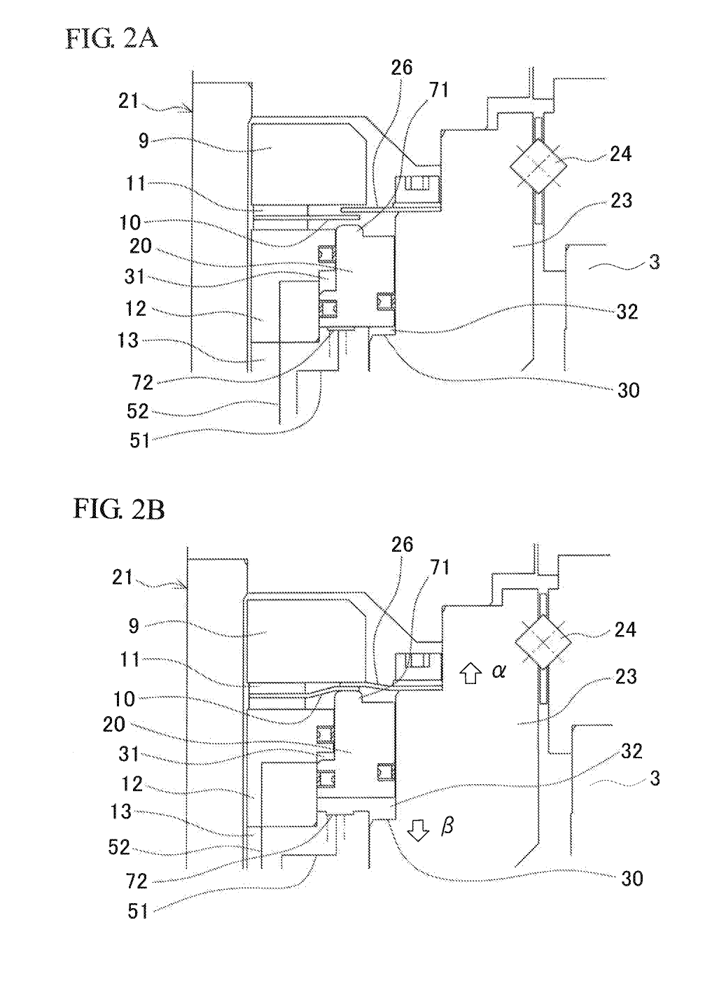

FIGS. 2A and 2B show operation of indexing the spindle head 2 by a small angle in the headstock 1. As shown in FIG. 2A, when the spindle head 2 is to be indexed, the pump P is operated to fill the first inlet chamber 31 with hydraulic oil to retract the piston 20 (move the piston 20 downward in FIG. 2). In a state where the brake head 9, the brake plate 26 of the braking member 23, and the brake plate 10 of the inner support portion 7 are separated from each other, the rotation drive mechanism 4 is operated to rotate the rotary spindle 21 about the rotation axis B. The rotation drive mechanism 4 is drivingly controlled by a control device, not shown.

When the rotary spindle 21 is rotated by a predetermined angle, the braking mechanism is operated to restrain rotation of the spindle head 2, as shown in FIG. 2B. That is, the hydraulic oil in the first inlet chamber 31 is forcibly discharged and the second inlet chamber 32 is filled with hydraulic oil to advance the piston 20 (move the piston 20 upward) by using an oil pressure (value of the pressure is P₁). The brake plate 26 of the braking member 23 is thus held between the brake head 9 and the brake plate 10 of the inner support portion 7, thereby restraining rotation of the braking member 23 with respect to the inner support portion 7.

As described above, the hydraulic oil in the first inlet chamber 31 is forcibly discharged and the second inlet chamber 32 is filled with hydraulic oil to advance the piston 20, whereby the brake plate 26 of the braking member 23 is held between the brake head 9 and the brake plate 10 of the inner support portion 7. In this case, reaction force due to bending of the brake plate 26 held between the brake head 9 and the brake plate 10 of the inner support portion 7 (restoring force to its original flat plate shape based on the portion pressed against the brake head 9) is transmitted to the braking member 23. Force α toward the top end is therefore applied to the rotary spindle 21 of the spindle head 2.

At the same time, the oil pressure P₁ of the hydraulic oil in the second inlet chamber 32 is applied to the oil pressure application surface 30 formed on the inner periphery of the braking member 23. Accordingly, the surface on the base end side (lower side in FIG. 1) of the second clutch member 61 fixedly attached to the braking member 23 presses the reference surface 19 toward the base end (downward in FIG. 1). Force β toward the base end is therefore applied to the rotary spindle 21. This force β toward the base end is determined by the oil pressure P₁ and the area of the oil pressure application surface 30, and is made to be larger than the force α toward the top end. Since the force β larger than the force α is applied to the rotary spindle 21 toward the base end, “force β−force α” is applied to the rotary spindle 21 toward the base end. Accordingly, in the headstock 1, the rotary spindle 21 is not displaced (shifted) toward the top end during braking operation as in the braking mechanism in which the piston 20 is merely advanced (moved upward in FIGS. 2A and 2B) to hold the brake plate 26 of the braking member 23 between the brake head 9 and the brake plate 10 of the inner support portion 7.

### (3) Advantages of Headstock

As described above, in the headstock 1, rotation of the rotary spindle 21 is restrained by the braking mechanism pressing the piston 20 against the brake plate 26 fixedly attached to the rotary spindle 21 by using an oil pressure. When the braking mechanism is operated, hydraulic force in the direction opposite to the direction in which the piston 20 is pressed against the brake plate 26 is applied to the braking member 23 of the rotary spindle 21 to press the braking member 23 against the reference surface 19 of the support base 3. Accordingly, in the headstock 1, the main spindle (spindle head 2) can be quickly rotated and indexed to an accurate position, the braking mechanism (brake mechanism) for the rotary spindle 21 can be produced inexpensively, and maintenance is easy. Moreover, the rotary spindle 21 is less likely to be displaced (shifted) when the rotary spindle 21 is braked.

As described above, in the headstock 1, the support base 3 that rotatably holds the rotary spindle 21 has the second inlet chamber 32 that is to be filled with hydraulic oil to be supplied to operate the piston 20. Moreover, the oil pressure application surface 30 is provided in the second inlet chamber 32 so as to face the base end face of the piston 20, and the pressure of hydraulic oil pressing the piston 20 is applied to the oil pressure application surface 30 when the rotary spindle 21 is braked. Accordingly, the hydraulic force can be efficiently applied in the opposite direction to the direction in which the piston 20 is pressed against the brake plate 26. This can more accurately prevent displacement of the rotary spindle 21.

As described above, in the headstock 1, the rotary spindle 21 is braked by using either the first braking mechanism (brake-type braking mechanism) or the second braking mechanism (clutch-type braking mechanism) according to the indexing angle. Accordingly, in the headstock 1, the rotary spindle 21 can be braked in a short time, and the spindle head 2 can be indexed to a very accurate position. Moreover, regardless of whether indexing is performed by the first braking mechanism or the second braking mechanism, the surface on the base end side (lower side in FIG. 1) of the second clutch member 61 is pressed (pressed downward in FIG. 1) against the reference surface 19. Therefore, displacement (shifting) of the rotary spindle 21 along the rotation axis B is reduced.

### (4) Modifications of Headstock

The configuration of the headstock of the machine tool according to the present invention is not limited to the above embodiment. The configuration of the spindle head (main spindle), the support base, the rotation drive mechanism, the rotary spindle, the piston, the brake plates, the inlet chambers, etc. may be modified as appropriate without departing from the spirit and scope of the invention. Moreover, the machine tool provided with the headstock of the present invention is not limited to such a combination machining lathe as in the present embodiment, and may be modified to various machine tools.

For example, the braking mechanism of the headstock is not limited to the configuration that brakes the rotary spindle by pressing the fixed brake plate by the piston and holding the rotating brake plate between the base end face of the brake head and the fixed brake plate as in the above embodiment. The braking mechanism of the headstock may be modified to the configuration in which the fixed brake plate is in contact with the base end face of the brake head and the rotary spindle is braked by pressing the rotating brake plate by the piston and holding the rotating brake plate between the top end face of the piston and the fixed brake plate.

The headstock is not limited to the configuration including both the braking mechanism (first braking mechanism) formed by the piston, the rotating brake plate, the fixed brake plate, etc. and the braking mechanism (second braking mechanism) formed by the first clutch member and the second clutch member, as in the above embodiment. The headstock may include only the braking mechanism formed by the piston, the rotating brake plate, the fixed brake plate, etc. or may include this braking mechanism and a braking mechanism other than the clutch-type braking mechanism.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A headstock of a machine tool, comprising:
a main spindle capable of rotating with a tool being attached thereto;
a rotary spindle capable of indexing the main spindle about a rotation axis perpendicular to the main spindle;
a support base rotatably holding the rotary spindle; and
a braking mechanism that restrains rotation of the rotary spindle, wherein
the braking mechanism restrains rotation of the rotary spindle by pressing a piston fixed to the support base against a brake plate fixedly attached to the rotary spindle by using an oil pressure, and
when the braking mechanism is operated, hydraulic force is applied to a braking member of the rotary spindle in an opposite direction to a direction in which the piston is pressed against the brake plate, so that the braking member is pressed against a reference surface provided in the support base.

2. The headstock of the machine tool according to claim 1, wherein
the support base rotatably holding the rotary spindle has an inlet chamber that is to be filled with hydraulic oil to be supplied to operate the piston, and
an oil pressure application surface is provided in the inlet chamber so as to face a base end face of the piston.

3. The headstock of the machine tool according to claim 1, further comprising:
in addition to the braking mechanism, a second braking mechanism that restrains rotation of the rotary spindle by causing a first clutch member fixed to the support base to mesh with a second clutch member fixedly attached to the rotary spindle by using an oil pressure, so that either the braking mechanism or the second braking mechanism is used according to an indexing angle, wherein
when the second braking mechanism is operated, the second clutch member meshing with the first clutch member by the oil pressure is pressed against the reference surface provided in the support base.

4. The headstock of the machine tool according to claim 2, further comprising:
in addition to the braking mechanism, the second braking mechanism that restrains rotation of the rotary spindle by causing the first clutch member fixed to the support base to mesh with the second clutch member fixedly attached to the rotary spindle by using an oil pressure, so that either the braking mechanism or the second braking mechanism is used according to an indexing angle, wherein
when the second braking mechanism is operated, the second clutch member meshing with the first clutch member by the oil pressure is pressed against the reference surface provided in the support base.
